(19) United States
(12) Patent Application Publication
(10) Pub. No.: US 2020/0134104 A1
(43) Pub. Date: Apr. 30, 2020

(54) TETRA MESH GENERATOR, TETRA MESH GENERATION METHOD, AND PROGRAM

(71) Applicant: SUMITOMO HEAVY INDUSTRIES, LTD., Tokyo (JP)

(72) Inventor: Yoshitaka Ohnishi, Kanagawa (JP)

(21) Appl. No.: 16/565,964

(22) Filed: Sep. 10, 2019

(30) Foreign Application Priority Data
Oct. 31, 2018 (JP) 2018-205606

(51) Int. Cl. G06F 17/50

(52) U.S. Cl. CPC G06F 17/50

(57) ABSTRACT

An input unit to which shape definition data that defines a three-dimensional shape is input. A processing unit disposes a plurality of particles on an edge and a surface of the three-dimensional shape defined by the input shape definition data, disposes particles according to an internal distribution rule in an inner part spaced apart from the surface of the three-dimensional shape, disposes particles at a position deviated from the position according to the internal distribution rule, in a space between the inner part and the surface of the three-dimensional shape, and generates a tetra mesh having a center of the disposed particles as a vertex.

### RELATED APPLICATIONS

The content of Japanese Patent Application No. 2018-205606, on the basis of which priority benefits are claimed in an accompanying application data sheet, is in its entirety incorporated herein by reference.

### BACKGROUND

### Technical Field

Certain embodiment of the present invention relates to a tetra mesh generator, a tetra mesh generation method, and a program.

### Description of Related Art

The related art discloses many tetra mesh generation methods. It is assumed that most of these tetra mesh generation methods are applied to a finite element method. Therefore, a molecular dynamics method based on a crystal lattice structure or a renormalization group molecular dynamics method (hereinafter, both are collectively referred to as a molecular dynamics method) may not be compatible.

### SUMMARY

If the analysis is performed by the molecular dynamics method using the tetra mesh generated by the method in the related art, the analysis accuracy may be remarkably lowered. In particular, a tetra mesh made by dividing a rectangular parallelepiped (see Japanese Unexamined Patent Publication No. 2003-75521) has low rigidity in the shear direction, and therefore analysis may break down if analysis is performed by the molecular dynamics method is performed using this mesh.

It is desirable to provide a tetra mesh generator, a tetra mesh generation method, and a program suitable for analysis by the molecular dynamics method or renormalization group molecular dynamics method.

According to one aspect of the present invention, there is provided a tetra mesh generator including:
an input unit to which shape definition data that defines a three-dimensional shape is input;
a processing unit that disposes a plurality of particles on an edge and a surface of the three-dimensional shape defined by the shape definition data input to the input unit, disposes particles according to an internal distribution rule in an inner part spaced apart from the surface of the three-dimensional shape, disposes particles at a position deviated from the position according to the internal distribution rule, in a space between the inner part and the surface of the three-dimensional shape, and generates a tetra mesh having a center of the disposed particles as a vertex.

According to another aspect of the present invention, there is provided a tetra mesh generation method including:
defining a three-dimensional shape;
disposing a plurality of particles on an edge and a surface of the three-dimensional shape;
disposing particles according to an internal distribution rule in an inner part spaced apart from the surface of the three-dimensional shape, and disposing particles at a position deviated from the position according to the internal distribution rule, in a space between the inner part and the surface of the three-dimensional shape; and
generating a tetra mesh having a center of the disposed particles as a vertex.

According to still another aspect of the invention, there is provided a program causing a computer to execute:
a function of inputting shape definition data that defines a three-dimensional shape;
a function of disposing a plurality of particles on an edge and a surface of the three-dimensional shape defined by the input shape definition data, disposing particles according to an internal distribution rule in an inner part spaced apart from the surface of the three-dimensional shape, disposing particles at a position deviated from the position according to the internal distribution rule, in a space between the inner part and the surface of the three-dimensional shape, and generating a tetra mesh having a center of the particles as a vertex; and
a function of outputting tetra mesh definition data that defines a generated tetra mesh.

A tetra mesh having a shape reflecting the atomic arrangement to be simulated can be generated in the inner part of the three-dimensional shape. In the space between the inner part and the surface, particles are displaced from the position according to the internal distribution rule, so the discontinuity of the mesh shape of the tetra mesh in the inner part and tetra mesh on the surface can be relaxed.

The accuracy of the simulation can be improved by disposing particles at the nodes of the tetra mesh and simulating the behavior of the particles using the molecular dynamics method or the renormalization group molecular dynamics method.

### BRIEF DESCRIPTION OF THE DRAWINGS

FIG. 1 is a block diagram of a tetra mesh generator according to an embodiment.

FIG. 2 is a flowchart of a tetra mesh generation method according to an embodiment.

FIG. 3 is a perspective view showing an example of a three-dimensional shape defined in an STL format.

FIG. 4 is a perspective view of a three-dimensional shape in which a plurality of sections are color-coded by gray levels having different gradations.

FIG. 5A is an enlarged view of a part of the three-dimensional shape in which sections are color-coded by gray levels having different gradations, and FIG. 5B is a diagram in which spherical particles are displayed at the nodes of triangular elements on the edges.

FIG. 6 is a perspective view showing a plurality of nodes disposed on the edge.

FIG. 7 is a diagram for explaining a surface distribution rule for disposing particles on three-dimensional surface.

FIG. 8A is a diagram showing an example of the distribution of particles covering the three-dimensional surface, and FIG. 8B is an enlarged view of a part of FIG. 8A.

FIG. 9 is a schematic diagram for explaining a process of returning particles deviating from the three-dimensional surface onto the surface.

FIG. 10 is a schematic diagram of a state in which a space in which a three-dimensional shape is disposed is divided into a plurality of cells.

FIGS. 11A to 11C are schematic diagrams showing distribution of particles before performing a process (step S5) for relaxing breakdown of the surface distribution rule, and FIGS. 11D to 11F are schematic diagrams respectively showing distribution of the particles after the relaxation process of the example shown in FIGS. 11A to 11C.

FIG. 12 is a perspective view showing an example of an extra triangle that does not constitute a three-dimensional surface.

FIG. 13 is a box-and-whisker diagram showing distortion amount Q of a surface mesh obtained by changing the number of time steps of the equation of motion when the relaxation process of step S5 is performed.

FIG. 14A is a schematic diagram showing an example of the distribution of particles disposed inside a three-dimensional shape, particles on a surface, and particles on an edge, and FIG. 14B is a schematic diagram showing the distribution of particles after performing the process for relaxing a discontinuity of particle distribution density.

FIG. 15A is a schematic diagram showing an example in which the triangles constituting the surface mesh are not adopted as the surfaces of the tetrahedron of the tetra mesh, and FIG. 15B is a schematic diagram showing a tetra mesh after adjusting the vertex combinations of the tetrahedrons.

FIG. 16A is a perspective view of a finally created tetra mesh, and FIG. 16B is a perspective view of the tetra mesh before deleting an extra tetrahedron.

FIG. 17 is a cross-sectional view showing the shape of a tetra mesh formed inside a three-dimensional shape, and an enlarged view of a part of the cross-section.

### DETAILED DESCRIPTION

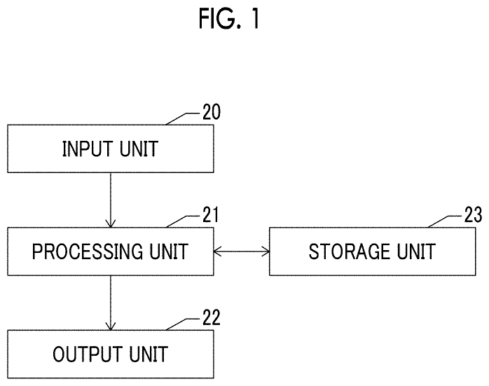

A tetra mesh generator and a tetra mesh generation method according to an embodiment will be described with reference to FIGS. 1 to 16B.

FIG. 1 is a block diagram of the tetra mesh generator according to the embodiment. The tetra mesh generator according to the embodiment includes an input unit 20, a processing unit 21, an output unit 22, and a storage unit 23. From the input unit 20, tetra mesh generation conditions, for example, shape definition data that defines a three-dimensional shape, mesh node spacing, basic conditions for node arrangement, and the like are input. Further, various instructions (commands) are input to the input unit 20 from the operator. The input unit 20 includes a communication device, a removable media reading device, and a keyboard, for example.

The processing unit 21 performs a process of generating a tetra mesh based on the input conditions, and outputs the processing result to the output unit 22. The processing result includes tetra mesh definition data that defines the shape of the tetra mesh. The processing unit 21 includes, for example, a computer, and a program for causing the computer to execute various functions for generating a tetra mesh is stored in the storage unit 23. The output unit 22 is a communication device, a removable media writing device, and a display.

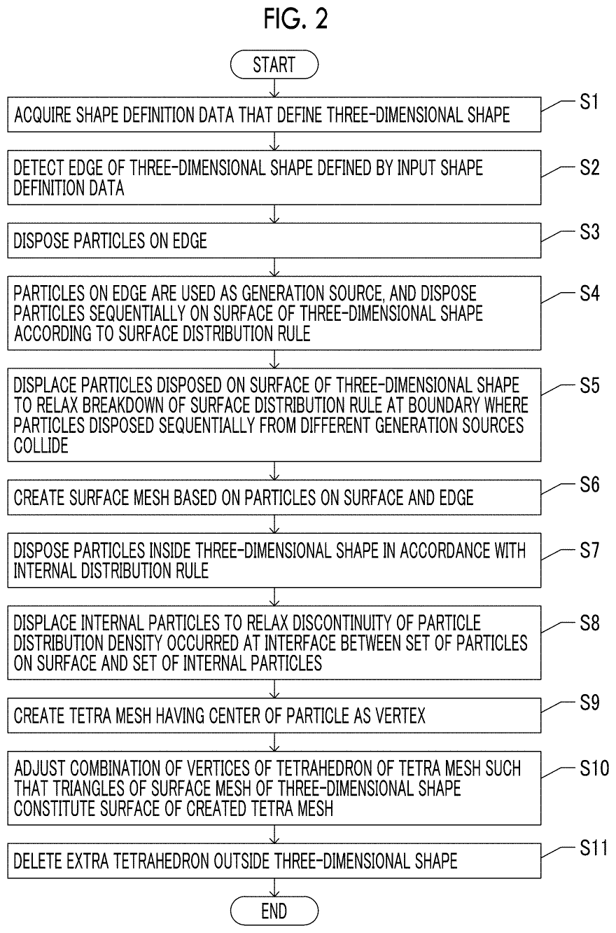

FIG. 2 is a flowchart of the tetra mesh generation method according to the embodiment.

In step S1, the processing unit 21 acquires shape definition data that defines a three-dimensional shape input from the input unit 20. The shape definition data is, for example, data in standard triangulated language (STL) format, and is created using three-dimensional CAD. The data in STL format reproduces a three-dimensional surface with a collection of small triangular elements.

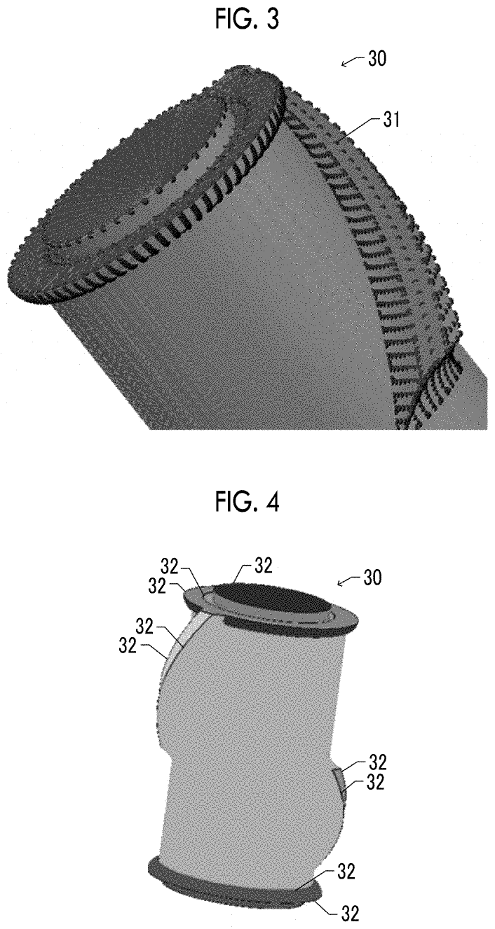

FIG. 3 is a perspective view showing an example of a three-dimensional shape 30 defined in the STL format. The three-dimensional model shown in FIG. 3 is a kneader roller. In FIG. 3, spherical particles 31 are shown at positions corresponding to the vertices of a plurality of triangular elements disposed on the surface of the three-dimensional shape 30. A large triangular element is disposed in the flat region and a region having a large radius of curvature, and a small triangular element is disposed in the region having a small radius of curvature.

In step S2 (FIG. 2), the processing unit 21 detects the edge of the three-dimensional shape 30 based on the shape definition data. Hereinafter, an example of a method for detecting an edge will be described.

A normal vector can be defined for each triangular element of the shape definition data. If the angle formed by the normal vectors of adjacent triangular elements is equal to or smaller than a predetermined threshold value, the two triangular elements belong to the same section. In a case where the angle formed by the normal vectors of adjacent triangular elements is larger than a predetermined threshold value, the two triangular elements belong to the different sections. For example, the threshold value is about 30 degrees. The boundary of a section is defined as an edge.

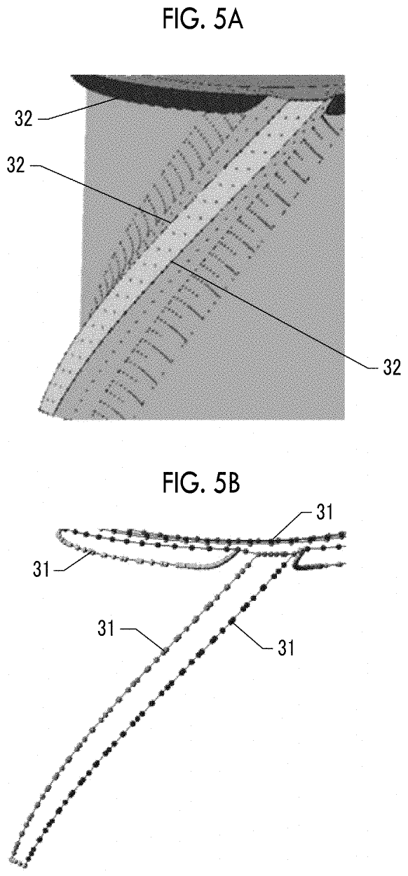

FIG. 4 is a perspective view of a three-dimensional shape 30 in which a plurality of sections are color-coded by gray levels having different gradations. FIG. 5A is an enlarged view of a part of the three-dimensional shape 30 in which a plurality of sections are color-coded by gray levels having different gradations. As shown in FIGS. 4 and 5A, an edge 32 is defined at the boundary of the section. FIG. 5B is a diagram in which spherical particles 31 are displayed at the nodes of triangular elements on the edges 32.

In step S3 (FIG. 2), a plurality of nodes are disposed on the edge 32 at equal intervals. This node corresponds to a node of the tetra mesh. The interval between the nodes is input from the input unit 20 (FIG. 1) as a condition for generating a tetra mesh.

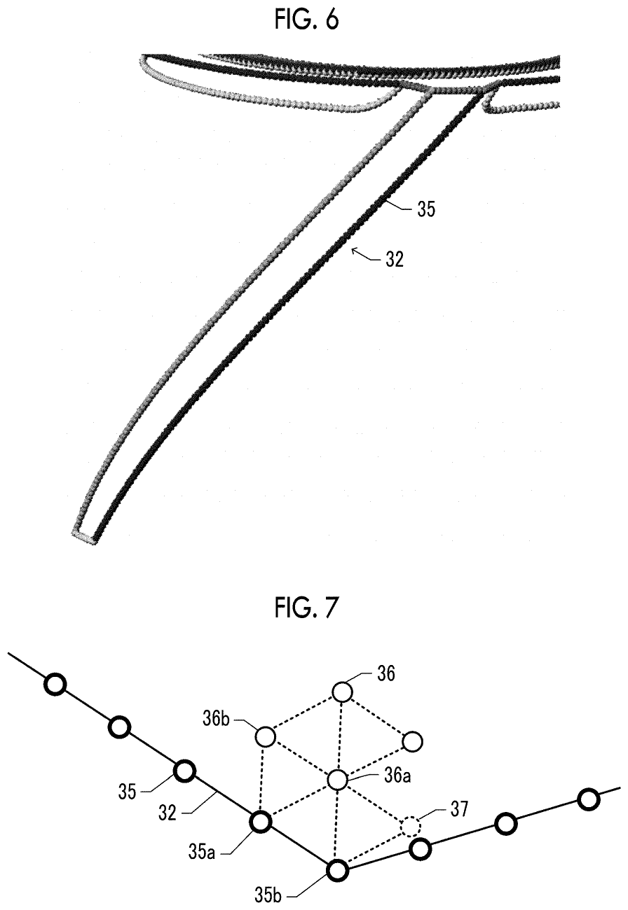

FIG. 6 is a perspective view showing a plurality of nodes disposed on the edge 32. In FIG. 6, spherical particles 35 are displayed at positions corresponding to the nodes. In a case where the tetra mesh generated in the present embodiment is applied to the molecular dynamics method, particles are disposed at the positions of the nodes of the tetra mesh. Therefore, in the present specification, the nodes of the tetra mesh may be referred to as “particles”. The position of the node of the tetra mesh corresponds to the center position of the particle.

In step S4 (FIG. 2), the particles 35 (FIGS. 5A and 5B) on the edge 32 are used as the generation source, and the particles 36 are sequentially disposed on the surface of the three-dimensional shape 30 (FIG. 3) according to the surface distribution rule. The surface distribution rule will be described with reference to FIG. 7.

FIG. 7 is a diagram for explaining the surface distribution rule for disposing particles 36 on the three-dimensional surface 30 (FIG. 3). In step S3 (FIG. 2), a plurality of particles 35 are disposed on the edge 32 at equal intervals. Two adjacent particles 35a, 35b among the plurality of particles 35 on the edge 32 are used as generation sources, and a new element 36a is disposed at the same distance from the two generation sources (the interval between the particles 35 on the edge 32) and at a position on the triangular element of the three-dimensional shape 30. Subsequently, a new particle 36b is similarly disposed based on the particles 35a and 36a.

Thus, based on the position of the particle 35 on the edge 32 or the already disposed particle 36 on the surface, the same processing is repeated until the surface of the three-dimensional shape 30 is covered. By this processing, the region where the particle 36 on the surface is disposed expands (grows) from the particle 35 on the edge 32 which is the generation source. Ina case where the particle 35 or 36 is already disposed in the vicinity of the newly disposed particle 37, the particle 37 is not disposed. Here, “vicinity” means a range closer to the particle 35 than the interval between the particles 35 on the edge 32. A region grown from a common generation source is called a homogeneous region.

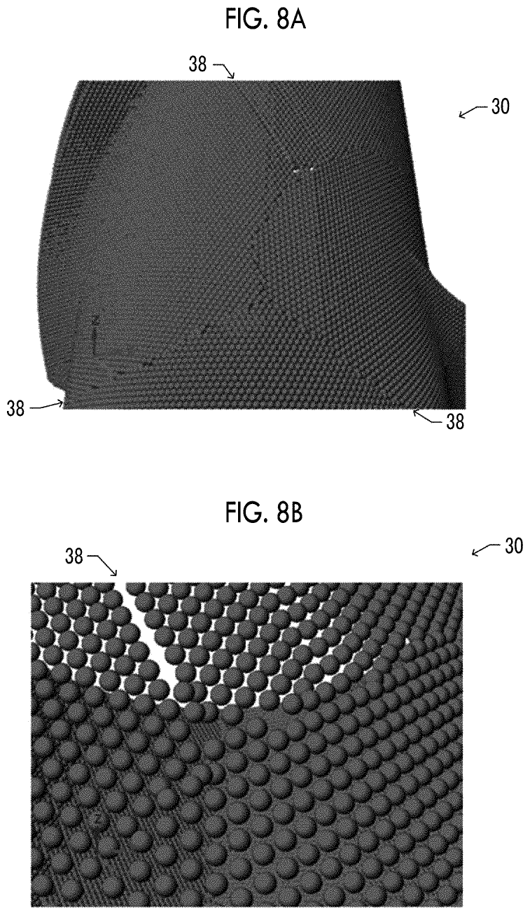

FIG. 8A is a diagram showing an example of the distribution of particles 36 covering the surface of the three-dimensional shape 30. FIG. 8B is an enlarged view of a part of FIG. 8A. A boundary 38 where a defect, a grain boundary or the like is generated appears at a position where two homogeneous regions grown from different generation sources collide. At this boundary 38, the surface distribution rule is broken.

In step S5 (FIG. 2), the particle 36 on the surface is displaced to relax the breakdown of the surface distribution rule at the boundary of the homogeneous region. Here, to relax the breakdown means to relax disorder of regularity of particle arrangement at the boundary. Hereinafter, an example of a process for relaxing the breakdown of the surface distribution rule will be described.

The interaction potential between the particle 35 on the edge 32 and the particle 36 on the surface is defined. The virtual particle is moved by solving the equation of motion using this interaction potential. It is assumed that the particles 35 on the edge 32 do not move.

Only repulsive force is considered, by using a spring model as the interaction potential. Further, the size of particles other than the particles on the edge 32 is set to zero, and the particles are expanded with the passage of time, that is, the particle size is increased. When the pressure acting on the particles exceeds a predetermined threshold, the expansion of the particles is stopped. For example, when it expands until it contacts with an adjacent particle, the expansion of the particle is stopped. In a case of solving the equation of motion in a state where the particles are almost in contact with each other, the particle hardly moves even if the time step of the equation of motion is repeated. By setting the initial value of the size of the particle to zero, the particle can be easily displaced.

The pressure Pi acting on the particle i is defined by the following expression.

$${P}_{i} = - \frac{1}{3 {V}_{i}} {\sum }_{j} {r}_{ij} \frac{d φ ( {r}_{ij} )}{{dr}_{ij}} \qquad ( 1 )$$

Here, j means a particle that interacts with the particle i, Vᵢ is the volume of the particle i, rᵢⱼ is the distance between the particle i and the particle j, and φ(rᵢⱼ) is the potential function between the particle i and the particle j.

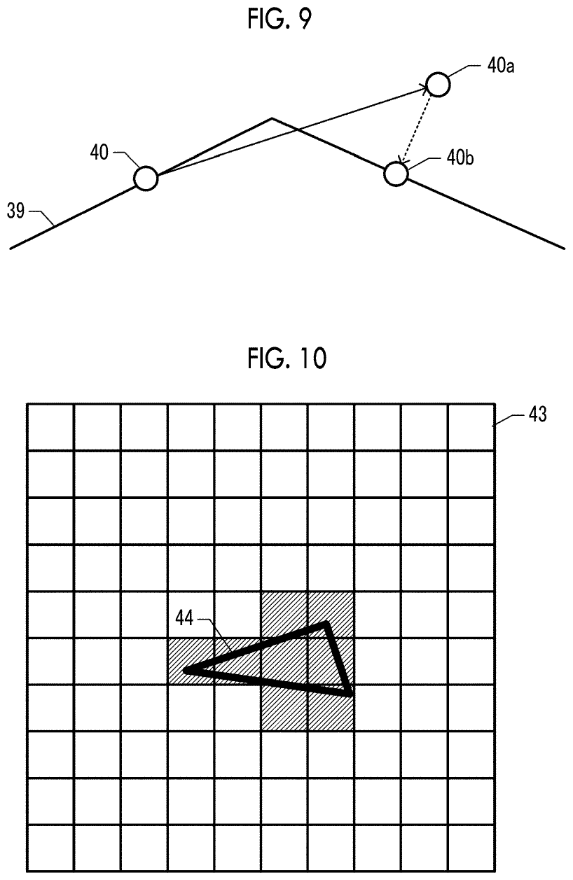

When the equation of motion is solved to move particles on the surface of the three-dimensional shape 30 (FIG. 3), the particles may deviate from the surface. Particles that deviate from the surface return to the surface of the three-dimensional shape 30. Next, the process of returning the particles to the surface will be described with reference to FIG. 9.

FIG. 9 is a schematic diagram for explaining a process of returning particles deviating from the three-dimensional surface onto the surface. When the equation of motion is solved and the particle 40 on the surface 39 advances one time step, it moves to the position of the particle 40a. The particle 40a deviates from the three-dimensional surface 39. At this time, a projected image obtained by vertically projecting the particle 40a onto the plane formed by the triangular element of the three-dimensional surface 39 is inside the triangular element, and a projected image 40b closest to the particle 40a is defined. The position of the projected image 40b is defined as the position after the particle 40 before solving the equation of motion is moved. Usually, since the distance from which the particle 40a after movement deviates from the surface 39 is small, a projected image vertically projected on a plane formed by a triangular element closest to the position of the particle 40a is adopted as the above-described projected image 40b.

Next, an example of a method for finding the triangular element closest to the position of the particle 40a deviating from the surface (FIG. 9) will be described with reference to FIG. 10.

FIG. 10 is a schematic diagram of a state in which a space in which the three-dimensional shape 30 (FIG. 3) is disposed is divided into a plurality of cells 43. FIG. 10 is the schematic diagram of the three-dimensional shape 30 as viewed from the perpendicular direction with respect to the surface. The space in which the three-dimensional shape 30 is disposed is divided into a plurality of cells 43. In advance, a triangular element and a cell 43 at which the triangular element intersects are associated and registered. Further, the cell 43 that does not intersect with any triangular element is associated with the triangular element that is closest to the cell 43. Data in which the cell 43 and the triangular element are associated is stored in the storage unit 23 (FIG. 1). In the example shown in FIG. 10, the hatched cell 43 is associated with a triangular element 44 indicated by a solid line.

After solving the equation of motion, a cell 43 containing particles 40a (FIG. 9) deviating from the surface is obtained. Based on the data in which the cell 43 and the triangular element are associated with each other, the triangular element associated with the cell 43 is extracted. In this way, by dividing the space in which the three-dimensional shape 30 is disposed into a plurality of cells 43 and associating the cells 43 with triangular elements, it is possible to find the triangular element closest to the position of the particle 40a deviating from the surface (FIG. 9).

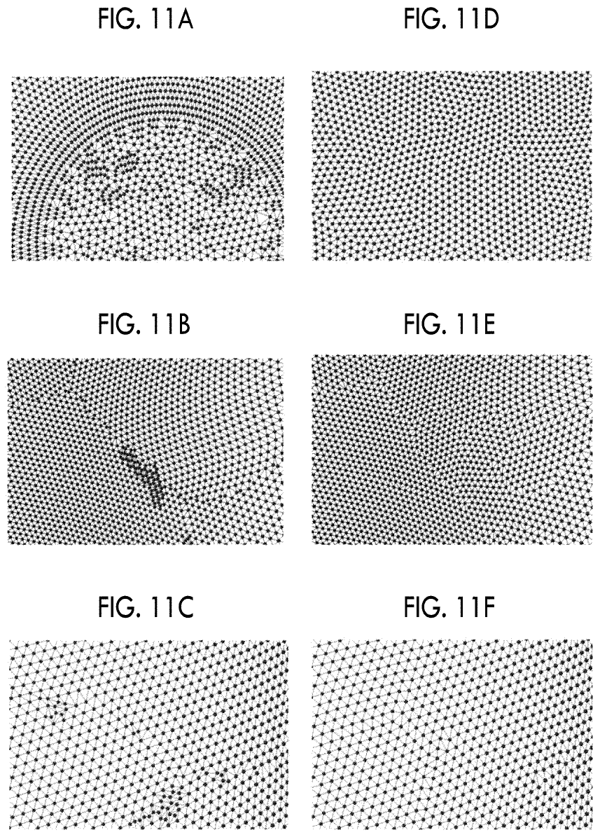

FIGS. 11A to FIG. 11C are schematic diagrams showing the distribution of particles before the processing (step S5) for relaxing the breakdown of the surface distribution rule. In the example shown in FIG. 11A, a region where the particle distribution density is relatively high and a region where the particle distribution density is relatively low are observed. In the example shown in FIG. 11B, a region where the distribution density of the particles is higher than the surroundings is observed. In the example shown in FIG. 11C, a region where the particle distribution density is locally high is observed.

FIGS. 11D to 11F are schematic diagrams showing the distribution of particles after the relaxation process of the examples shown in FIGS. 11A to 11C, respectively. In any of the examples, it can be seen that the particle distribution is approaching an even distribution. Thus, by performing the relaxation process of step S5, the distribution of the particles disposed on the surface of the three-dimensional shape 30 can be brought close to an even distribution.

In step S6 (FIG. 2), a surface mesh is created based on the position of the particles after the relaxation process. Hereinafter, a method for creating a surface mesh will be described.

Delaunay triangulation is performed based on the position of the particles after the relaxation process. Specifically, first, three particles are selected, and a sphere including the center of the three particles on the surface is considered. However, the intersection of the plane and the sphere obtained from the center position of the three particles is assumed to be a great circle. If there is no other particle inside the sphere, a triangle with the center position of the selected three particles as the vertex is adopted as a part of the surface mesh.

However, in this method, a triangle that does not actually constitute the surface of the three-dimensional shape 30 may be adopted as a part of the surface mesh. By deleting such triangles, a surface mesh is completed.

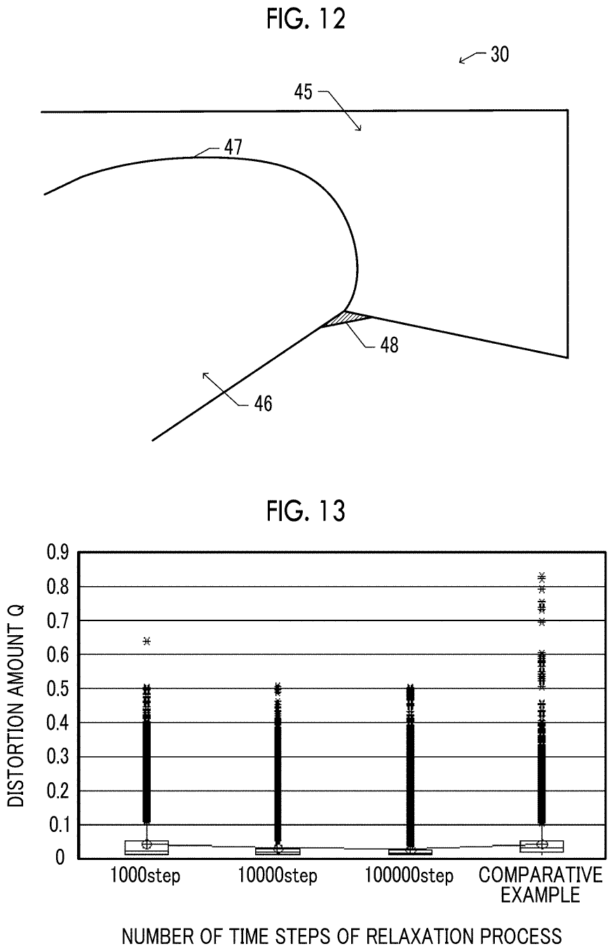

FIG. 12 is a perspective view showing an example of an extra triangle that does not constitute the surface of the three-dimensional shape 30. The surface 45 and the surface 46 of the three-dimensional shape 30 intersect at an intersection line 47. In this way, an extra triangle 48 including particles on the intersection line 47 where the two surfaces meet is likely to be adopted as a part of the surface mesh. Each of the triangles constituting the surface mesh of the three-dimensional shape 30 is connected to the three triangles through the three sides. However, the extra triangle 48 continues to the adjacent triangle through two sides, but does not continue to another triangle through the remaining one side. This side is not shared with other triangles . In this way, triangles whose number of triangles adjacent to each other through the side is not three are deleted as extra triangles.

The distortion amount Q of the surface mesh created in this way is obtained by calculation. The distortion amount Q is defined by the following expression.

$$Q = max [ \frac{{θ}_{max} - {θ}_{e}}{180 - {θ}_{e}} , \frac{{θ}_{e} - {θ}_{min}}{{θ}_{e}} ] \qquad ( 2 )$$

Here, θₘₐₓ and θₘᵢₙ are the maximum value and the minimum value of the interior angles of the triangles constituting the surface mesh, respectively. θₑ is one interior angle of the equilateral triangle, that is, 60°. The distortion amount Q=0 when all the triangles of the surface mesh are regular triangles, and the distortion amount Q=1 when all the vertices of the triangles are arranged on one straight line.

FIG. 13 is a box-and-whisker diagram showing distortion amount Q of a surface mesh after the relaxation process obtained by changing the number of time steps of the equation of motion when the relaxation process of step S5 is performed. For reference, a distortion amount Q of a surface mesh generated using commercially available mesh generation software is shown as a comparative example.

It can be seen that the distortion amount Q decreases as the number of time steps of relaxation process increases. Further, it can be seen that the distortion amount Q of the surface mesh created by the method according to the present embodiment is smaller than the distortion amount Q of the surface mesh created using commercially available software in the related art. In a case where the analysis is performed by a molecular dynamics method using a tetra mesh, it is empirically found that the distortion amount Q is 0.5 or less. By the method according to the present embodiment, a surface mesh that satisfies this condition can be generated.

In step S7 (FIG. 2), particles are disposed inside the three-dimensional shape 30 in accordance with the internal distribution rule. As the internal distribution rule, for example, a rule that particles are disposed at atomic positions of a face-centered cubic lattice is adopted. This rule is particularly effective in a case where a metal having a face-centered cubic lattice structure is simulated by a molecular dynamics method. In the case of simulating a metal having a body-centered cubic lattice structure or a hexagonal close-packed structure, a rule that particles are disposed at atomic positions of these structures may be adopted as an internal distribution rule.

Next, the particle arrangement method will be described more specifically. First, the particles are disposed so as to cover the inside of the three-dimensional shape 30 (FIG. 3) and the entire surface mesh. The particle radius is the atomic radius of the lattice structure applied to the internal distribution rule. For example, when a face-centered cubic lattice is employed as the internal distribution rule, the particle radius r is defined by the following expression using the lattice constant a.

$$r = \frac{\sqrt{2}}{4} a \qquad ( 3 )$$

Next, the particles overlapping with the particles 35 36 (FIGS. 6, 7) on the surface and the edge are deleted. The radii of the particles 35, 36 on the surface and the edge are the same as the radius of the particle disposed according to the internal distribution rule. The coupled particle pair is obtained from the distance between the centers of the particles disposed according to the internal distribution rule. The bonded particles are classified into the same group. Since the particles overlapping with the particles 35, 36 on the surface and the edge are deleted, the particles disposed according to the internal distribution rule are classified into two groups. Of the two groups of particles, the particles of the group determined to be disposed outside the three-dimensional shape 30 are deleted. As a result, particles can be disposed only inside the three-dimensional shape 30.

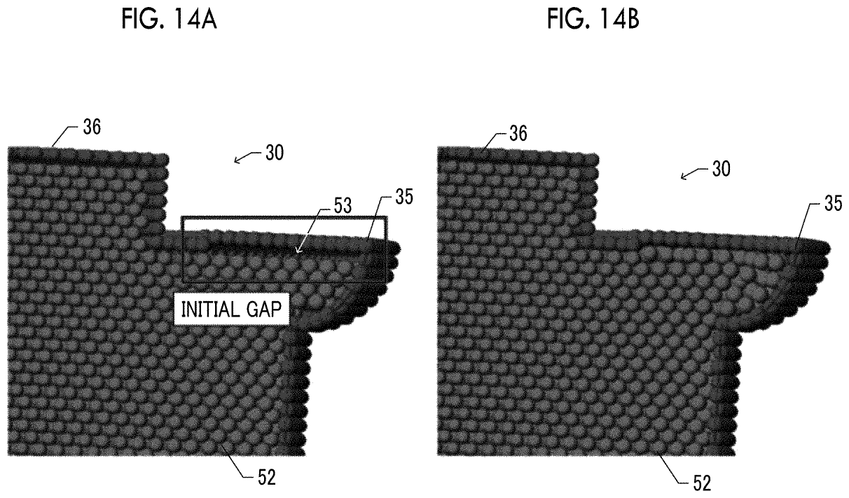

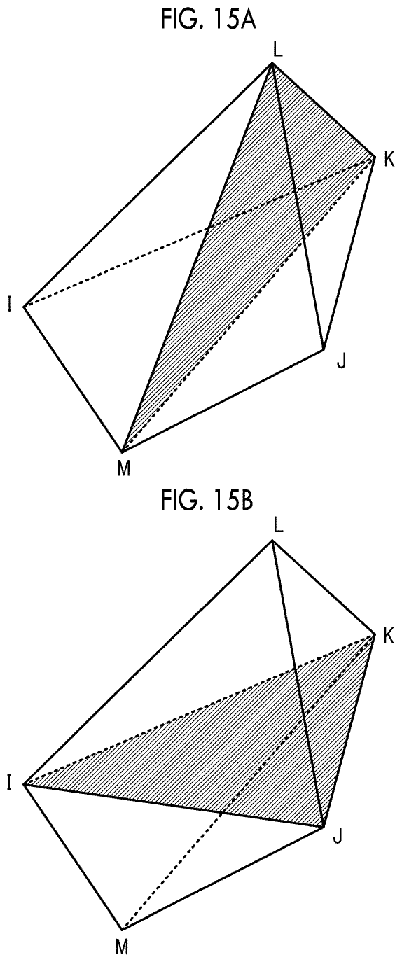

FIG. 14A is a schematic diagram showing an example of the distribution of the particles 52 disposed inside the three-dimensional shape 30, the particles 36 on the surface, and the particles 35 on the edge. Among the particles disposed in accordance with the internal distribution rule, the particles overlapping the particles 36 on the surface and the particles 35 on the edge are deleted, so an initial gap 53 having a size smaller than the diameter of the particle 52 is generated at the interface between the set of internal particles 52 and the set of the particles 36, 35 on the surface and edge. That is, a portion in which the particle distribution density changes discontinuously occurs at the interface between the set of internal particles 52 and the set of the particles 36, 35 on the surface and edge.

In step S8 (FIG. 2), the internal particles 52 are displaced to relax discontinuities in the particle distribution density. The method for displacing the internal particles 52 is the same as the method for displacing the particles disposed on the surface in step S5. In the process of displacing the internal particles 52, the process of returning the particles deviating from the surface to the surface is unnecessary. Further, the particles 36, 35 on the surface and the edge are not moved.

FIG. 14B is a schematic diagram showing the distribution of particles after the processing for relaxing discontinuities in the particle distribution density. It can be seen that the initial gap 53 (FIG. 14A) that has occurred at the interface between the set of internal particles 52 and the set of the particles 36, 35 on the surface and edge has almost disappeared.

In step S9 (FIG. 2), a tetra mesh having the center of the internal particle 52, the particle 36 on the surface, and the particle 35 (FIG. 14B) on the edge as the vertex is created. For example, a Delaunay triangulation method can be used to create the tetra mesh. However, the tetra mesh created by this method may cause a situation in which the triangles constituting the surface mesh are not adopted as the surfaces of the tetrahedron of the tetra mesh.

FIG. 15A is a schematic diagram showing an example in which the triangles constituting the surface mesh are not adopted as the surfaces of the tetrahedron of the tetra mesh. Nodes I, J, K are disposed on the surface of the three-dimensional shape 30 (FIG. 3), a node L is disposed inside the three-dimensional shape 30, and a node M is disposed outside the surface including the nodes I, J, K. One tetrahedron IKLM having nodes I, K, L, M as vertices is created, and another tetrahedron JKLM having nodes J, K, L, M as vertices is created. In FIG. 15A, the interface KLM of two tetrahedrons is hatched. In this case, the triangle IJK having the nodes I, J, K as vertices is not adopted as one surface of the tetrahedron. The tetrahedron IKLM and the tetrahedron JKLM penetrate the triangle IJK of the surface mesh.

In step S10 (FIG. 2), the combination of the vertices of the tetrahedron is adjusted such that all the triangles constituting the surface mesh constitute the surfaces of the tetrahedron of the tetra mesh.

FIG. 15B is a schematic diagram showing the tetra mesh after the combination of the vertices of the tetrahedron is adjusted. Hereinafter, a method of adjusting the combination of the vertices of the tetrahedron will be described. First, a tetrahedron penetrating the surface mesh is extracted. In the example of FIG. 15A, a tetrahedron IKLM and a tetrahedron JKLM are extracted. Two tetrahedrons IJKL and tetrahedron IJKM are created by changing the combination of the vertices of the two tetrahedrons. In FIG. 15B, the interface IJK of two tetrahedrons is hatched. In the example shown in FIG. 15B, a triangle IJK constituting a surface mesh is adopted as the surfaces of the tetrahedron of the tetra mesh.

In a case where the three tetrahedrons pass through two adjacent triangles of the surface mesh, the combination of the vertices of the three tetrahedrons is adjusted in the same manner. The same processing is performed in a case where a plurality of tetrahedrons pass through three or more adjacent triangles of the surface mesh.

In step S11 (FIG. 2), unnecessary tetrahedrons, that is, tetrahedrons outside the three-dimensional shape 30 are deleted. Next, a method for deleting unnecessary tetrahedrons will be described.

First, tetrahedrons positioned on the surface are extracted from the created tetrahedrons of the tetra mesh. For example, in a case where there is no other tetrahedron that shares one surface of the tetrahedron, the surface is determined to be a surface. If the surface determined to be a surface does not match the triangle of the surface mesh, the tetrahedron is deleted. When the tetrahedron is deleted, anew surface appears, so the new surface is compared with the triangle of the surface mesh. By repeating the process of deleting the tetrahedron, the outer tetrahedron of the three-dimensional shape 30 is deleted, and only the inner tetrahedron remains.

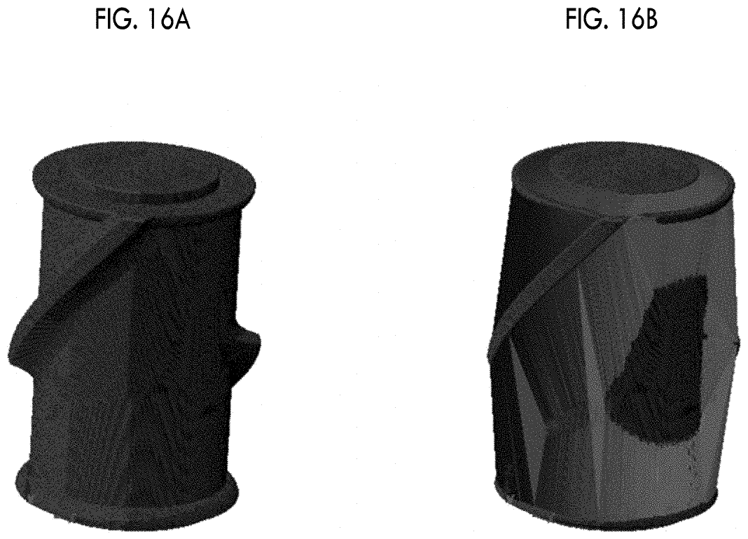

FIG. 16A is a perspective view of the finally created tetra mesh. FIG. 16B is a perspective view of the tetra mesh before deleting the extra tetrahedron. The tetra mesh shown in FIG. 16B includes a tetrahedron disposed outside the three-dimensional shape 30 so as to embed a surface depression. By deleting the tetrahedron outside the three-dimensional shape 30, the tetra mesh shown in FIG. 16A is obtained.

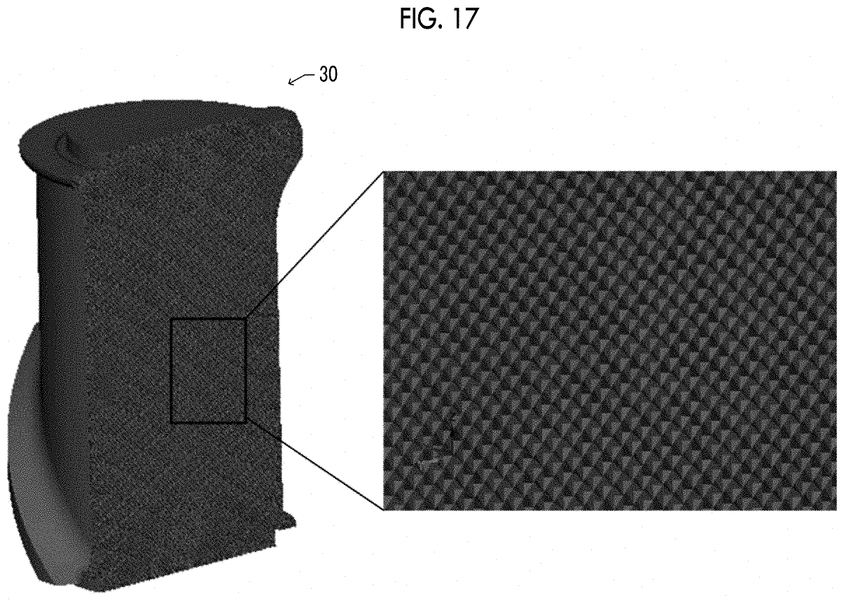

FIG. 17 is a cutaway perspective view showing the shape of the tetra mesh formed inside the three-dimensional shape 30 and a cross-sectional view in which a part of the cross-section is enlarged. It can be seen that a tetra mesh substantially corresponding to a face-centered cubic lattice is formed in the inner part spaced apart from the surface of the three-dimensional shape 30. In the relaxation process in step S8 (FIG. 2), the particles at the inner part are substantially not moved. Therefore, the arrangement of the particles 52 according to an internal distribution rule is maintained in the inner part. In the space between the inner part and the surface, particularly in the surface layer part, the particles 52 are displaced, so the particles 52 are disposed at positions slightly deviated from the positions according to the internal distribution rule.

Next, the excellent effects of the above embodiment will be described.

In the above embodiment, a tetra mesh having a shape reflecting the atomic arrangement to be simulated can be generated in the inner part of the three-dimensional shape. Further, the particles can be disposed almost evenly on the surface or edge of the three-dimensional shape. In the space between the inner part and the surface, particles are displaced from the position according to the internal distribution rule, so the discontinuity of the mesh shape of the tetra mesh in the inner part and tetra mesh on the surface can be relaxed.

The accuracy of the simulation can be improved by disposing particles at the nodes of the tetra mesh and simulating the behavior of the particles using the molecular dynamics method or the renormalization group molecular dynamics method.

The present invention is not limited to the embodiment described above. It will be apparent to those skilled in the art that various modifications, improvements, combinations, and the like can be made.

It should be understood that the invention is not limited to the above-described embodiment, but may be modified into various forms on the basis of the spirit of the invention. Additionally, the modifications are included in the scope of the invention.

What is claimed is:

1. A tetra mesh generator comprising:
an input unit to which shape definition data that defines a three-dimensional shape is input; and
a processing unit that disposes a plurality of particles on an edge and a surface of the three-dimensional shape defined by the shape definition data input to the input unit, disposes particles according to an internal distribution rule in an inner part spaced apart from the surface of the three-dimensional shape, disposes particles at a position deviated from the position according to the internal distribution rule, in a space between the inner part and the surface of the three-dimensional shape, and generates a tetra mesh having a center of the disposed particles as a vertex.

2. The tetra mesh generator according to claim 1,
wherein the processing unit
disposes particles on the edge of the three-dimensional shape, and then sequentially disposes particles on the surface of the three-dimensional shape according to the surface distribution rule by using the particles disposed on the edge as generation sources, and
displaces the particles disposed on the surface of the three-dimensional shape to relax breakdown of the surface distribution rule at a boundary where particles disposed sequentially from different generation sources collide.

3. The tetra mesh generator according to claim 2,
wherein the processing unit
disposes particles inside the three-dimensional shape, according to the internal distribution rules, and
displaces the particles inside the three-dimensional shape to relax a discontinuity of a particle distribution density occurring at an interface between a set of particles on the surface after the breakdown of the surface distribution rule is relaxed and a set of particles inside the three-dimensional shape.

4. The tetra mesh generator according to claim 3, further comprising:
an output unit,
wherein the processing unit
in a process of generating a tetra mesh, generates a tetra mesh with a center of the particle as a vertex, based on positions of the particles on the edge of the three-dimensional shape, the particles on the surface after relaxing the breakdown of the surface distribution rules, and the particles inside the three-dimensional shape after relaxing the discontinuity in the particle distribution density, and
outputs tetra mesh definition data defining the generated tetra mesh to the output unit.

5. The tetra mesh generator according to claim 4,
wherein the processing unit deletes unnecessary tetrahedrons outside the three-dimensional shape, after generating the tetra mesh with the center of the particle as the vertex and before outputting the tetra mesh definition data.

6. A tetra mesh generation method comprising:
defining a three-dimensional shape;
disposing a plurality of particles on an edge and a surface of the three-dimensional shape;
disposing particles according to an internal distribution rule in an inner part spaced apart from the surface of the three-dimensional shape, and disposing particles at a position deviated from the position according to the internal distribution rule, in a space between the inner part and the surface of the three-dimensional shape; and
generating a tetra mesh having a center of the disposed particles as a vertex.

7. A program causing a computer to execute:
a function of inputting shape definition data that defines a three-dimensional shape;
a function of disposing a plurality of particles on an edge and a surface of the three-dimensional shape defined by the input shape definition data, disposing particles according to an internal distribution rule in an inner part spaced apart from the surface of the three-dimensional shape, disposing particles at a position deviated from the position according to the internal distribution rule, in a space between the inner part and the surface of the three-dimensional shape, and generating a tetra mesh having a center of the particles as a vertex; and
a function of outputting tetra mesh definition data that defines the generated tetra mesh.
